(19) United States
(12) Patent Application Publication
(10) Pub. No.: US 2017/0314402 A1
(43) Pub. Date: Nov. 2, 2017

(54) METHOD FOR PRODUCING A BLADE FOR A TURBOMACHINE

(71) Applicant: MTU Aero Engines AG, Munich (DE)

(72) Inventors: Martin SCHLOFFER, Munich (DE); Wilfried SMARSLY, Munich (DE)

(21) Appl. No.: 15/497,695

(22) Filed: Apr. 26, 2017

(30) Foreign Application Priority Data
Apr. 27, 2016 (EP) 16167369.4

(51) Int. Cl. F01D 5/28; B22F 3/105; B22F 3/15; C22F 1/18; B33Y 10/00; B22F 7/08; B33Y 80/00; B22F 3/24

(52) U.S. Cl. CPC F01D 5/28; B33Y 80/00; B22F 3/1055; B22F 3/15; B22F 3/24; C22F 1/183; B33Y 10/00; B22F 7/08; F05D 2230/20; F05D 2230/41; F05D 2230/42; F05D 2300/174; B22F 2003/248

(57) ABSTRACT

Disclosed is a method for producing a blade for a turbomachine, which method comprises:
providing a blade root, having a first platform region, from a first material;
providing on the first platform region at least one capsule that is filled with a metallic and/or ceramic powder that comprises at least one second material which is different from the first material, for producing a blade airfoil having a second platform region;
producing and shaping a blade airfoil from the capsule that is filled with the powder by at least one thermal input method, thereby connecting the blade root to the blade airfoil in respective platform regions.

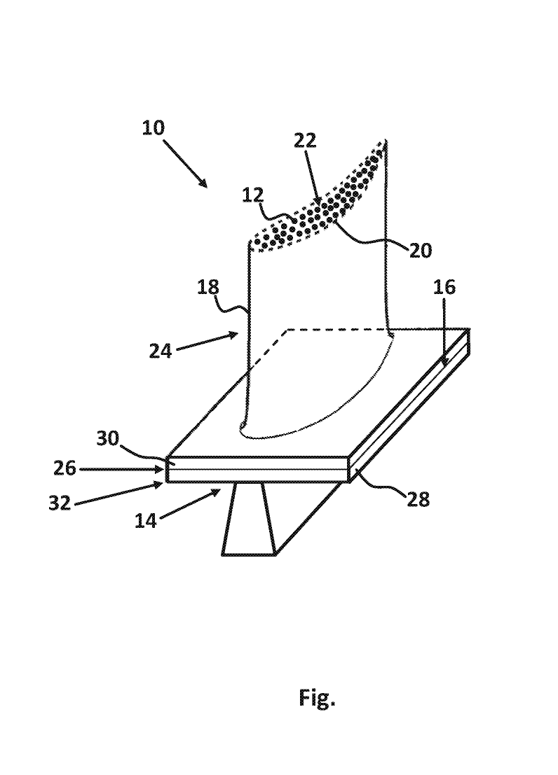

Also disclosed is a blade which is obtainable and/or obtained by this method.

### CROSS-REFERENCE TO RELATED APPLICATIONS

The present application claims priority under 35 U.S.C. §119 of European Patent Application No. 16167369.4, filed Apr. 27, 2016, the entire disclosure of which is expressly incorporated by reference herein.

### BACKGROUND OF THE INVENTION

### 1. Field of the Invention

The invention relates to a method for producing a blade for a turbomachine, in particular for an aircraft engine. A further aspect of the invention relates to a blade of this type which is obtainable and/or obtained by a respective method.

### 2. Discussion of Background Information

in order for high reliability to be guaranteed, maximum care has to be taken in the manufacturing of blades for turbomachines. In terms of the concept and the production of the blades a significant challenge lies in that said blades are to withstand extreme mechanical and thermal stresses, on the one hand, and as high a degree of efficiency as possible is to be achieved in the operation of the turbomachine, on the other hand.

A method for producing turbine blades by a layer-application method is known from EP 1 878 522 A1. The turbine blades therein are obtained from a metallic powder by means of electron beam sintering. DE 10 2013 205 956 A1 describes the production of blades from dissimilar materials. The blades therein are formed in a generative manner by overlay welding of a TiAl powder on a disk. A further known method for the production of components from a powder can be derived from EP 2 551 040 A1. DE 10 2012 201 082 A1 shows a method for producing forged components from a TiAl alloy. The components therein are shaped by so-called isothermal forging, and are subsequently subjected to a heat treatment. The use of a TiAl alloy for producing components of a turbomachine is also known from EP 2 905 350 A1. Further methods for the production of blades are specified in the DE 10 2012 222 745 A1 and JP 2008 208432 A. The entire disclosures of all of the documents mentioned above are incorporated by reference herein.

It would be advantageous to have available a method of the type mentioned at the outset that permits a flexible choice of materials in the production of a blade and thus blade manufacturing that is adapted particularly to the mechanical and thermal stresses of the blade. It would further be advantageous to have available a blade in which the materials of individual components of the blade are selectable in a particularly flexible manner.

### SUMMARY OF THE INVENTION

The present invention provides a method for producing a blade for a turbomachine, in particular for an aircraft engine. The method comprises:
providing a blade root, having a first platform region, made of a first material;
providing on the first platform region at least one capsule that is filled with a metallic and/or ceramic powder that comprises at least one second material which is different from the first material, for producing a blade airfoil having a second platform region;
producing and shaping a blade airfoil from the capsule that is filled with the powder by at least one thermal input method, thereby connecting the blade root to the blade airfoil in respective platform regions.

In one aspect of the method, the capsule may be produced from the powder by a generative production method, for example, by electron beam melting and/or by selective laser melting, and filled with the powder. In another aspect, the capsule may be produced by the generative production method by a layer-by-layer construction of the capsule on the blade root.

In yet another aspect, prior to production of the capsule by the generative production method and/or prior to filling of the capsule, the powder may be heated to a heating temperature which is lower than the melting temperature and/or than the sintering temperature of the powder.

In as still further aspect, the capsule may be filled with the powder in that in the generative production method at least one part-region of the capsule is produced layer-by-layer from the powder as a hollow section that is closed on a circumferential side, and thereby at least a part-quantity of the powder is surrounded at least by the part-region.

In another aspect of the method, the capsule may be provided in such a manner that negative pressure is generated in an interior space of the capsule that is configured for receiving the powder.

In another aspect, a connection region of the blade airfoil in which the latter is connected to the blade root may be produced from the first material and/or from the second material.

In another aspect, a blade root face of the blade root at which the latter is connected to the blade airfoil may be smoothed by a subtractive method and/or by an electrolytic method prior to being connected.

In another aspect of the method, the at least one thermal input method may comprise hot isostatic pressing.

In another aspect, the blade airfoil, after production thereof, may be subjected to local annealing in order to set the grain size distribution and/or the blade root and the blade airfoil, after connecting, may be subjected to a common age annealing.

In another aspect, the blade root may be produced in that a body from the first material is provided, forged, annealed for homogenization, and subsequently shaped into the blade root.

In another aspect of the method, a TiAl alloy, e.g., a γ-TiAl alloy may be provided as the first material and/or a TiAl alloy, e.g., a TiAl alloy which, apart from Ti and Al, comprises as further alloy component one or more elements from the group W, Mo, Nb, Co, Hf, Y, Zr, Er, Gd, Si, C, may be provided as the second material.

The present invention also provides a blade for a turbomachine, in particular for an aircraft engine, that is obtained or obtainable by the method set forth above (including the various aspects thereof), as well a turbomachine which comprises this blade.

As set forth above, a first aspect of the invention relates to a method for producing a blade for a turbomachine, in particular for an aircraft engine, said method comprising at least the following:
producing a blade root, having a first platform region, from a first material;
providing at least one capsule that is filled with a metallic and/or ceramic powder, for producing a blade airfoil having a second platform region on the first platform region, wherein the powder comprises at least one second material which is different from the first material;
producing and shaping the blade airfoil from the capsule that is filled with the powder by at least one thermal input method, thereby connecting the blade root to the blade airfoil in the respective platform regions.

The two platform regions can be connected to form one platform, thereby connecting the blade root to the blade airfoil. Here, the platform can be a so-called inner shroud. The production of the blade root can be implemented by forging, for example, and can be carried out separately from providing the blade airfoil. The first material can be so-called TNM-TiAl, for example, which can also be referred to as titanium aluminide (or in short: γ-titanium, wherein the letters N and M refer to the elements niobium and molybdenum, respectively). This group of materials is distinguished by a particularly high thermal resistance and simultaneously low density. Accordingly, this material is particularly suitable for producing components therefrom which in the intended use thereof are exposed to high temperatures and high centrifugal forces. The powder with which the capsule is filled can be formed from one or a plurality of metallic materials, and additionally or alternatively from one or a plurality of ceramic materials, for example. If two or more different metals are used, a so-called intermetallic compound can be formed from the powder by the thermal input method. Use of a mixture of metallic and ceramic materials as the powder is also conceivable herein. The capsule can impart a shape to the blade airfoil, such that a desired final shape of the blade airfoil can be predefined by an external contour of the capsule and by a correspondingly shaped interior space of the capsule, for example. Moreover, negative pressure which can be generated already in the production of the capsule, for example, can prevail in the interior space of the capsule. Disposing the capsule that is already filled with the powder on the blade root can already be performed when the capsule is provided at the blade root. Alternatively thereto, constructing of the capsule on the blade root and simultaneous filling of the capsule with the powder can be performed by a generative production method, for example. In the construction of the capsule on the blade root, producing the capsule, on the one hand, and disposing the capsule on the blade root, on the other hand, as a matter of principle can be performed simultaneously. The capsule that is filled with the powder can be subjected to said thermal input method conjointly with the blade root, wherein heating of the powder to a melting temperature or to a sintering temperature of the powder can be performed in the thermal input method, for example. In this way, the blade airfoil can be produced from the capsule that is filled with the powder, for example, in that the capsule is evacuated (generating the negative pressure in the interior space of the capsule), is baked out, is welded to the blade root, and is subjected to hot isostatic pressing (in short: HIP) as the thermal input method. The powder in this HIP can be consolidated and diffusion-welded to the blade root. As the second material from which the blade airfoil can be produced, a high-alloyed TiAl material to which alloy components such as W, Mo, Nb and/or Co can be added, can be employed, for example, to mention only a few possible alloy components. A particularly flexible selection of materials in the production of the blade results from the use of the second material which is different from the first material, on account of which blade manufacturing that is adapted particularly to the mechanical and thermal stresses of the blade is enabled.

In an advantageous embodiment of the invention, the capsule is produced from the powder by a generative production method, in particular by electron beam melting and/or by selective laser melting (also referred to as SLM), and is filled with the powder. Producing the capsule as well as additionally and simultaneously joining said capsule to the blade root can be performed by generative production methods of this type. An in situ production of the capsule on the blade root is thus possible, in which the blade root can be placed in a powder bed that is composed of the powder and the capsule by way of the generative production method can be constructed layer-by-layer from the powder. As has already been mentioned, the first material and the second material can be two mutually dissimilar TiAl alloys which can be connected to one another by the generative production method. Accordingly, the capsule and the blade root can be connected in a particularly reliable manner by the generative production method at a common connection zone which is associated with a connection region of the blade airfoil and at least one part-face of a blade root face of the blade root. This connection zone can correspond to a region of the blade that is stressed in a non-critical manner, and have a particularly large cross-sectional area. Filling of the capsule with the powder can be performed by way of an opening that is proved on the capsule and opens into the interior space, for example, wherein the opening after filling can be closed by the generative production method, and the capsule can thus be sealed. Filling of the capsule after the production thereof has the advantage that a pulverulent material that is dissimilar to the first material and to the second material can be filled into the capsule as the powder. A particularly flexible selection of materials is thus possible.

In a further advantageous embodiment of the invention, the capsule is produced by the generative production method by a layer-by-layer construction of the capsule on the blade root. The capsule herein can be constructed directly on the blade root, on account of which the blade overall can be produced in particularly few manufacturing steps.

In a further advantageous design embodiment of the invention, the powder prior to the production of the capsule by the generative production method, and/or prior to filling of the capsule, is heated to a heating temperature which is lower than a melting temperature and/or than a sintering temperature of the powder. This provides a plurality of advantages. By way of heating the powder to the heating temperature during the production of the capsule, any air that is located between the powder grains can be heated and, on account thereof, the air density of said air can be reduced. Initial sintering of at least individual powder grains can additionally already arise at the heating temperature. After the capsule has been closed in relation to the environment, in the case of subsequent cooling of the powder, of the air that remains in the interior space, and of the capsule, negative pressure can be created in the latter, or negative pressure that already exists can be amplified. On account thereof, particularly effective compression of the powder in the capsule can be performed, and the blade airfoil can be produced so as to have a particularly low proportion of pores and correspondingly high stability. A further advantage of heating is that providing the capsule can be significantly accelerated on account thereof. The reason therefor lies in that sintering or fusing of the powder grains to form the capsule can be performed from the pre-heated powder from which the capsule can be produced by way of only a slight further increase in the temperature. Heating the powder to the heating temperature accordingly accelerates the production of the blade airfoil from the powder such that an input of only a minor amount of energy is required in order for the powder to be heated from the heating temperature to the melting temperature or the sintering temperature, and for the blade airfoil to be produced from the powder by hot isostatic pressing, for example. Furthermore, a minor proportion of air as a result of the generation of negative pressure contributes toward any undesirable oxidation processes of the powder when the latter is heated being less pronounced than would be the case at an atmospheric air pressure and with correspondingly higher proportions of air in the powder.

In a further advantageous embodiment of the invention, the capsule is filled with the powder in that in the generative production method at least one part-region of the capsule is produced layer-by-layer from the powder as a hollow section that is closed on the circumferential side, and herein at least a part-quantity of the powder is surrounded at least by the part-region. In the layer-by-layer construction of the capsule (in the generative production method), the powder is thus enclosed in the capsule. No separate operational step in which the powder would have to be filled into the capsule is thus required. Filling of the capsule with particularly low complexity can thus be achieved in the generative production method.

In a further advantageous embodiment of the invention, the capsule is provided in such a manner that negative pressure is generated in an interior space of the capsule that is configured for receiving the powder. A state which is particularly close to a vacuum in the capsule is to be ideally set by generating the negative pressure. The powder that is located in the interior space receives particularly little air by generating the negative pressure, which is why the blade airfoil to be produced from the powder also has few pores and is thus particularly stable. Generating the negative pressure can be performed during the production of the capsule such that the capsule is produced in an operation chamber that is impinged with negative pressure, for example. In principle, however, it would also be possible for the capsule to first be constructed at atmospheric pressure, and for excess air to be subsequently suctioned from the interior space through an exit opening in the capsule, wherein the exit opening would subsequently have to be closed.

In a further advantageous embodiment of the invention, a connection region of the blade airfoil in which the latter is connected to the blade root is produced from the first material and/or from the second material. The connection region of the blade airfoil can simultaneously correspond to a capsule base of the capsule at which the latter can be connected to a blade root face of the blade root. The reason therefor is that the blade airfoil can be shaped from the capsule and from the powder that is contained therein. In the production of the blade airfoil from the powder, the latter can be consolidated by sintering or fusing, and conjointly with the capsule be connected to the blade airfoil, wherein a materially integral fit can be formed between the connection region and the blade root. The connection region can be produced from bare TiAl, thus from TNM-TiAl, for example, which is dissimilar to the second material. In principle, a production of the connection region from the first material and, additionally or alternatively, from the second material is conceivable as long as this is permissible in the context of the requirements set for the mechanical and/or thermal resilience.

In a further advantageous embodiment of the invention, a blade root face of the blade root at which the latter is connected to the blade airfoil, prior to being connected is smoothed by a subtractive method and/or by an electrolytic method. A particularly durable connection between the blade root and the blade airfoil can be achieved by smoothing the blade root face before connecting. Smoothing can be performed on a blade root face of the blade root, for example. Mechanical (for example subtractive) or electrolytic machining can be performed for the smoothing, and the blade root face can be smoothed in order for a bare metallic joining face to be provided.

In a further advantageous embodiment of the invention, the at least one thermal input method is carried out as hot isostatic pressing. The capsule that is filled with the powder in hot isostatic pressing (HIP) can be compressed at high pressures and temperatures, and the blade airfoil, on account thereof, can be produced from the capsule and the powder that is contained therein. Insofar as the capsule in the production by a generative production method has not already been connected to the blade root anyway, diffusion welding of the capsule to the blade root can be performed simultaneously in the hot isostatic pressing. A very thin defined connection zone which by way of a respective geometric selection of the capsule and of the blade root can be positioned at the largest cross section of the finished blade results herein. This is particularly favorable, since the lowest stresses arise on the largest cross section in the intended use of the blade. In the case of HIP, a microstructure in the blade root, produced from TNM-TiAl, for example, is transformed into a so-called triplex microstructure having a high globular gamma proportion, on account of which a good subtractive machining capability of the blade root can be achieved, for example.

In a further advantageous embodiment of the invention, the blade airfoil, after production thereof, in order for a distribution of grain size to be set, is subjected to local annealing. In this annealing, overall furnace annealing of the entire blade, or alternatively local inductive heating of the blade airfoil from the high-alloyed TiAl alloy, can be performed subsequent to production. These types of annealing are carried out in a temperature range in which a homogenous distribution of grain size in the blade can be achieved such that optimum creep resistance can be set in the blade airfoil and high strength can be set in the blade root.

In a further advantageous embodiment of the invention, the blade root and the blade airfoil, after connecting, are subjected to common age annealing. The entire blade can be subject to age annealing of this type in a suitable temperature range, wherein the formation of precipitation hardening can arise in the blade airfoil. While precipitation in the blade airfoil is indeed generated by age annealing, at the same time the properties in the blade root that is produced from TNM-TiAl, for example, are not negatively influenced by age annealing.

In a further advantageous embodiment of the invention, the blade root is produced in that a body from the first material is provided, forged, annealed for homogenization, and is subsequently shaped into the blade root. The blade root can be produced, for example, from said body which is configured as a plate from TNM-TiAl, for example. This plate, following forging and annealing for homogenization thereof, can be subdivided into cuboid-shaped semi-finished products for the production of a plurality of blade roots, for example. The semi-finished products can then be shaped into the blade roots. This represents a particularly cost-effective production method in which a plurality of blade feet can be provided with low complexity.

In a further advantageous embodiment of the invention, a TiAl alloy, in particular a γ-TiAl alloy, is provided as the first material. A γ-TiAl alloy of this type, which can also be referred to as TNM-TiAl, has a particularly high thermal resistance and simultaneously low density. γ-TiAl is thus particularly suitable for the application in aircraft engines, thus as a material for the blade root, for example.

In a further advantageous embodiment of the invention, a TiAl alloy, in particular a TiAl alloy which apart from Ti and Al as a further alloy component comprises at least one element from the group of W, Mo, Nb, Co, Hf, Y, Zr, Er, Gd, Si, and C, is provided as the second material. A particularly targeted setting of component properties can be achieved by using these alloy components. These alloys are thus particularly suitable for setting desired component properties of the blade airfoil, for example.

A second aspect of the invention relates to a blade for a turbomachine, in particular for an aircraft engine, which is obtainable and/or obtained by a method according to the invention. A blade of this type can be provided in the case of a particularly flexible selection of materials. The materials herein can be combined with one another depending on the type of stress of the blade. Further features and the advantages thereof can be derived from the descriptions of the first aspect of the invention, wherein advantageous embodiments of the first aspect of the invention are to be considered as advantageous design embodiments of the second aspect of the invention, and vice versa.

Further features of the invention are obtained from the claims, the FIGURE and the exemplary embodiments. The features and combinations of features cited in the description above and the features and combinations of features cited in the exemplary embodiments below and/or described alone can be used not only in the respectively indicated combination but also in other combinations or on their own without departing from the scope of the invention. Therefore, embodiments of the invention that are not shown or explained explicitly in the exemplary embodiments, but emerge and are producible from the explained embodiments by virtue of separate combinations of features, can also be regarded as covered and disclosed by the invention.

### BRIEF DESCRIPTION OF THE DRAWING

The single FIGURE shows a schematic perspective view of a blade according to the invention for a turbomachine.

### DETAILED DESCRIPTION OF EMBODIMENT OF THE INVENTION

The FIGURE shows a blade 10 for a turbomachine for an aircraft engine. As in the present exemplary embodiment, the blade 10 can be configured as a rotor blade for a rotor main body that is not illustrated in more detail here. Alternatively, however, the blade 10 could also be configured as a guide vane of a guide vane apparatus, for example.

A blade root 14 of the blade 10 has a first platform region 28 and is in the present case produced from a first material that is formed from a γ-TiAl alloy, wherein the γ-TiAl alloy can be a TNM-TiAl alloy. The blade root 14 herein is shaped from a forged body, annealed for homogenization, from the first material.

The FIGURE furthermore shows a capsule 18 which has an interior space 22 that is filled with a metallic powder 12. The capsule 18 has a second platform region 30, is disposed on a blade root face 16 on the first platform region 28 of the blade root 14, and in the present exemplary embodiment imparts a shape to a blade airfoil 24 of the blade 10. The capsule 18 is formed by a generative production method, in the present exemplary embodiment by electron beam melting, from a powder bed (not illustrated in more detail here) that is filled with the powder 12. The capsule 18 is constructed layer-by-layer and directly on the blade root face 16 of the blade root 14. On account thereof, the two platform regions 28, 30 are connected to form one platform 32, and the blade root 14 is thus connected to the blade airfoil 24. The platform 32 herein can be a so-called inner shroud. In order for a particularly durable connection between the capsule 18 and the blade root 14 to be produced, the blade root face 16 and thus the first platform region 28, prior to connecting, has been smoothed by an electrolytic method.

In order for the construction of the capsule 18 on the blade root 14 (on the blade root face 16) to be accelerated, the powder 12 prior to the production of the capsule has been heated to a heating temperature which is below a sintering temperature of the powder 12. On account thereof, sintering of the powder 12 while producing the capsule 18 is possible at further input of energy that is only minor. Filling of the interior space 22 of the capsule 18 with the powder 12 is performed by the generative production method in that at least a part-region 20 (illustrated with dashed lines in the FIGURE) of the capsule 18 has been produced from the powder 12 layer-by-layer as a hollow section that is closed on the circumferential side. Herein, a part-quantity of the powder 12 from the powder bed has been surrounded by the part-region 20 and been enclosed in the capsule 18 during the construction of the capsule 18. Moreover, in order for any oxidation processes to be reduced and in order for the powder 12 to be compressed during the production of the capsule 18, negative pressure has been generated in the interior space 22 of the capsule 18.

The powder 12 is in the present case formed from a second material which is different from the first material. The second material is configured as a TiAl alloy which apart from Ti and Al comprises tungsten (W) as the further alloy component. The TiAl alloy can also comprise other or a plurality of elements from the group of W, Mo, Nb, Co, Hf, Y, Zr, Er, Gd, Si, and C, in order for the material properties of the powder 12 and thus of the blade airfoil 24 that is to be produced therefrom to be set as precisely as possible.

Producing and shaping the blade airfoil 24 from the capsule 18 that is filled with the powder 12 is performed by a thermal input method which in the present exemplary embodiment corresponds to hot isostatic pressing. Diffusion welding of a connection region 26 of the blade airfoil 24 and of the blade root 14 on the blade root face 16, and simultaneously a consolidation of the powder 12 that is enclosed in the interior space 22 of the capsule 18 arise thereby. The connection region 26 herein is assigned to both the blade airfoil 24 as well as the capsule 18, especially since the blade airfoil 24 in the thermal input method is formed from the capsule 18 and the powder 12 that is contained in the interior space 22 of said capsule 18.

The blade airfoil 24, after the production thereof, in order for a distribution of grain size to be set is subjected to local annealing. Furthermore, the blade root 14 and the blade airfoil 24, after connecting, are subjected to common age annealing, in order for targeted precipitation hardening to be initiated.

The blade 10 can now be fixed to the rotor main body (not shown here) by joining the blade root 14, for example by way of a push-fit connection.

In summary, the method proposed enables the use of a plurality of materials and thus of dissimilar TiAl alloys for the production of the blade 10. The dissimilar material properties of the respective materials in the blade 10 can thus also be utilized in a targeted manner. A flexible selection of materials is thus possible in the production of the blade root 14 and of the blade airfoil 24, and the overall blade 10, on account thereof, is capable of being designed and produced in a particularly precise manner in terms of the stresses to be expected. The blade airfoil 24, on account of being produced from the capsule 18 that is filled with the powder 12, can be provided with particularly good creep properties. This would not be possible by virtue of requirements pertaining to a minimum ductility of the blade 10, if the latter in a manner known from the prior art were only formed from one material.

On account of the method described, the blade 10, by consolidating the powder 12 in the capsule 18 and on account of the diffusion welding of the latter on the blade root 14 that is produced by forging, can be configured as a graduated component from various TiAl materials. The capsule 18 herein can be constructed in situ on the blade root 14, and the blade airfoil 24 can be generated by hot isostatic pressing (HIP) from the capsule 18 that is filled with the powder 12.

Novel high-temperature resistant and high-alloyed TiAl alloys are considered to be particularly brittle. On account thereof, the design of a connection of the blade root 14 to the rotor main body which can also be referred to as a disk is very difficult in terms of any stresses and sustainable plastic deformations in a contact region between the blade root 14 and the disk, and in the blade root 14 per se. Since the blade root 14 is exposed to lower temperature stresses but to higher tension than the blade airfoil 24, but the blade airfoil 24 is to withstand the highest creep stresses, this leads to mechanical issues in design and production. The reason lies in that the creep resistance can only be increased at the cost of ductility.

These issues can at least be reduced by using dissimilar materials for the blade root 14 and the blade airfoil 24. The use of dissimilar TiAl materials of which the mechanical properties are adapted in an optimal manner to the local requirements enables the implementation in terms of construction of mechanically separable connections between the blade and the disk, while maintaining the weight advantage of TiAl. The blade root 14 and the blade airfoil 24 which in each case can be produced from dissimilar TiAl materials, by hot isostatic pressing are connected by an at least partially powder-metallurgical production process by in situ diffusion welding in the thickest cross section on the blade root face 16 of the blade root 14 and in the connection region 26. Mutually dissimilar microstructures which contribute toward meeting the requirements pertaining to the resilience of the blade 10 are set in both parts, that is to say in the blade root 14 and in the blade airfoil 24, by a corresponding heat treatment (annealing, age annealing) of the blade 10 that is thus achieved. The blade root 14 in this instance has particularly high ductility and strength, offset by low creep resistance. By contrast, the blade airfoil 24 has a particularly high creep resistance and consistent strength up to a temperature of up to 900° C., at the cost of strength at low temperature and of low ductility. TiAl alloys having high proportions of W, Mo, Nb, Co, Hf, Y, Zr, Er, Gd, Si, C can be used as the second material for the production of the blade airfoil 24, without any requirements pertaining to ductility of the blade root 14 being undershot.

### LIST OF REFERENCE NUMERALS

10 Blade
12 Powder
14 Blade root
16 Blade root face
18 Capsule
20 Part-region
22 Interior space
24 Blade airfoil
26 Connection region
28 First platform region
30 Second platform region
32 Platform

What is claimed is:

1. A method for producing a blade for a turbomachine, wherein the method comprises:
providing a blade root, having a first platform region, produced from a first material;
providing on the first platform region at least one capsule that is filled with a metallic and/or ceramic powder that comprises at least one second material which is different from the first material, for producing a blade airfoil having a second platform region;
producing and shaping a blade airfoil from the capsule that is filled with the powder by at least one thermal input method, thereby connecting the blade root to the blade airfoil in respective platform regions.

2. The method of claim 1, wherein the capsule is produced from the powder by a generative production method and is filled with the powder.

3. The method of claim 2, wherein the capsule is produced by electron beam melting and/or by selective laser melting,

4. The method of claim 2, wherein by the generative production method the capsule is produced by a layer-by-layer construction of the capsule on the blade root.

5. The method of claim 2, wherein prior to production of the capsule by the generative production method and/or prior to filling of the capsule the powder is heated to a heating temperature which is lower than a melting temperature and/or than a sintering temperature of the powder.

6. The method of claim 2, wherein the capsule is filled with the powder in that in the generative production method at least one part-region of the capsule is produced layer-by-layer from the powder as a hollow section that is closed on a circumferential side, and thereby at least a part-quantity of the powder is surrounded at least by the part-region.

7. The method of claim 1, wherein the capsule is provided in such a manner that negative pressure is generated in an interior space of the capsule that is configured for receiving the powder.

8. The method of claim 1, wherein a connection region of the blade airfoil in which the latter is connected to the blade root is produced from the first material and/or from the second material.

9. The method of claim 1, wherein a blade root face of the blade root at which the latter is connected to the blade airfoil, is smoothed by a subtractive method and/or by an electrolytic method prior to being connected.

10. The method of claim 1, wherein the at least one thermal input method comprises hot isostatic pressing.

11. The method of claim 1, wherein the blade airfoil, after production thereof, is subjected to local annealing in order to set a grain size distribution.

12. The method of claim 1, wherein the blade root and the blade airfoil, after connecting, are subjected to a common age annealing.

13. The method of claim 1, wherein the blade root is produced in that a body from the first material is provided, forged, annealed for homogenization, and is subsequently shaped into the blade root.

14. The method of claim 1, wherein a TiAl alloy is provided as the first material.

15. The method of claim 14, wherein the TiAl alloy comprises a γ-TiAl alloy.

16. The method of claim 1, wherein a TiAl alloy is provided as the second material.

17. The method of claim 16, wherein the TiAl alloy, apart from Ti and Al, comprises as further alloy component one or more of W, Mo, Nb, Co, Hf, Y, Zr, Er, Gd, Si, C.

18. The method of claim 14, wherein a TiAl alloy is provided as the second material.

19. A blade for a turbomachine, wherein the blade is obtained by the method of claim 1.

20. A turbomachine, wherein the turbomachine comprises the blade of claim 19.
